(19) United States
(12) Patent Application Publication
(10) Pub. No.: US 2021/0042663 A1
(43) Pub. Date: Feb. 11, 2021

(54) DATA ATTRIBUTION BASED ON SPATIAL MEMORY USING MACHINE LEARNING PIPELINE

(71) Applicant: CurieVision, Inc., Seattle, WA (US)

(72) Inventors: Michael Agustin, Seattle, WA (US); Ryan Grose, Edmonds, WA (US); Harrison Friia, Mays Landing, NJ (US); Quoc Vong Tran, Austin, TX (US)

(21) Appl. No.: 16/989,762

(22) Filed: Aug. 10, 2020

Related U.S. Application Data
(60) Provisional application No. 62/884,523, filed on Aug. 8, 2019.

(51) Int. Cl. G06N 20/00; G06K 9/62; G06T 15/20; G06T 7/70; G06T 7/11; G06K 9/34; G06K 9/46

(52) U.S. Cl. CPC G06N 20/00; G06K 9/6256; G06T 15/205; G06K 9/4604; G06T 7/11; G06K 9/344; G06T 7/70

(57) ABSTRACT

Techniques are described herein for providing data attribution based on spatial memory using a machine learning pipeline. The techniques include receiving, from a client device, an image of an object, wherein the image appended with object-specific data. The techniques further include extracting one or more features of the object from the object-specific data. The features may be included in a product catalog from one or more data sources. Based at least on one or more features associated with the object, a suggested category for the image is determined and associated with the image. The suggested category and the image may be used to train a machine learning model via a machine learning classification algorithm to predict a label for the image. The machine learning model is applied to assign the label to the image based at least on the suggested category.

### CROSS-REFERENCE TO RELATED PATENT APPLICATIONS

This application claims priority to U.S. Provisional Patent Application No. 62/884,523, filed on Aug. 8, 2019, and entitled “Data Attribution Based on Spatial Memory Using Machine Learning Pipeline,” which is hereby incorporated by reference in its entirety.

### BACKGROUND

Labeling is an essential stage of data processing in supervised learning. Historical data with predefined target attributes are generally used for model training. Various labeling approaches used may depend on the size and complexity of training data. Inaccurate labeling can negatively affect a dataset's quality and the overall performance of a predictive model. Additionally, significant financial and time resources must be allocated to implement labeling.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 illustrates an example system architecture for predicting labels for images using data attribution and suggested categories.

FIG. 2 illustrates an example image of an object that is appended to object-specific data and associated with a location from which the image was taken.

FIG. 3 is a block diagram showing various components of an illustrative computing device that predicts labels for images using data attribution and suggested categories.

FIG. 4 is a flow diagram of an example process for predicting a label associated with client-provided data.

FIG. 5 is a flow diagram of an example process for generating a three-dimensional object based on client-provided data.

### DETAILED DESCRIPTION

Described is a technique for predicting labels for images using data attribution and suggested categories. Techniques include receiving, at a suggestion discriminator, client-provided data such as image data corresponding to an image of an object. The image may be appended to information related to the object such as product data describing the properties or characteristics of the object, the object's location data (e.g., indicating where the object is sold), and other object-specific data. The object-specific data may be retrieved from various product catalogs that may be managed by a retailer. The object-specific data may also be retrieved from image catalogs, image databases, and/or search engine databases that may be managed by a search engine provider or a database management service provider. The object-specific data may also be directed provided by a user via client devices, image capture devices, and/or other such devices for providing image data.

The suggestion discriminator may extract one or more features of the object from the object-specific data. In some examples, one or more features may also be included in a product catalog from one or more data sources. The suggestion discriminator determines a suggested category for the image based at least on the one or more features of the object. In some aspects, user interactions with the image or user behavior may be analyzed to determine a suggested category. Additionally, the images may include an identifiable text (e.g., product identification numbers), markings (e.g., logos, branding), computer-readable code (e.g., a QR code, a barcode, etc.), and/or other indicia that may facilitate automatic categorizing of the image of the object. In some aspects, the suggestion discriminator may implement an image processor to transform low-quality images to increase the likelihood of successful labeling or discarded from further analysis.

Upon determining a suggested category for the image, the suggestion discriminator generates a labeled dataset by associating the suggested category with the image. The labeled dataset is fed to a machine learning pipeline that may be configured to train machine learning models using various machine learning classification algorithms. The machine learning pipeline may be a component of an image synthesizer or may be implemented as a separate system. The trained machine learning models may be applied by a classifier to predict and assign a label for an image. In some aspects, the classifier may apply different machine learning models trained via respective machine learning algorithms. Additionally, or alternatively, a classifier may be selected from a plurality of classifiers to predict and assign a label for an image.

In some examples, multiple images may be processed via an object generator in order to create a three-dimensional asset associated with an object depicted in the images. The three-dimensional asset may be a three-dimensional image of the object that is constructed from the images of an object from different view angles. The images may be appended to information related to the object such as product data describing the properties or characteristics of the object, the object's location data (e.g., indicating where the object is sold), and other object-specific data. Upon creating a three-dimensional asset, an image synthesizer may generate additional images (i.e., two-dimensional) of the object based at least on the three-dimensional asset The image synthesizer may append object-specific data and/or other information related to the product to the newly generated additional images to create additional labeled dataset. The labeled dataset is fed to a machine learning pipeline that may be configured to train machine learning models using various machine learning classification algorithms.

The techniques described herein may be implemented in a number of ways. Example implementations are provided below with reference to the following figures.

### Example Network Architecture

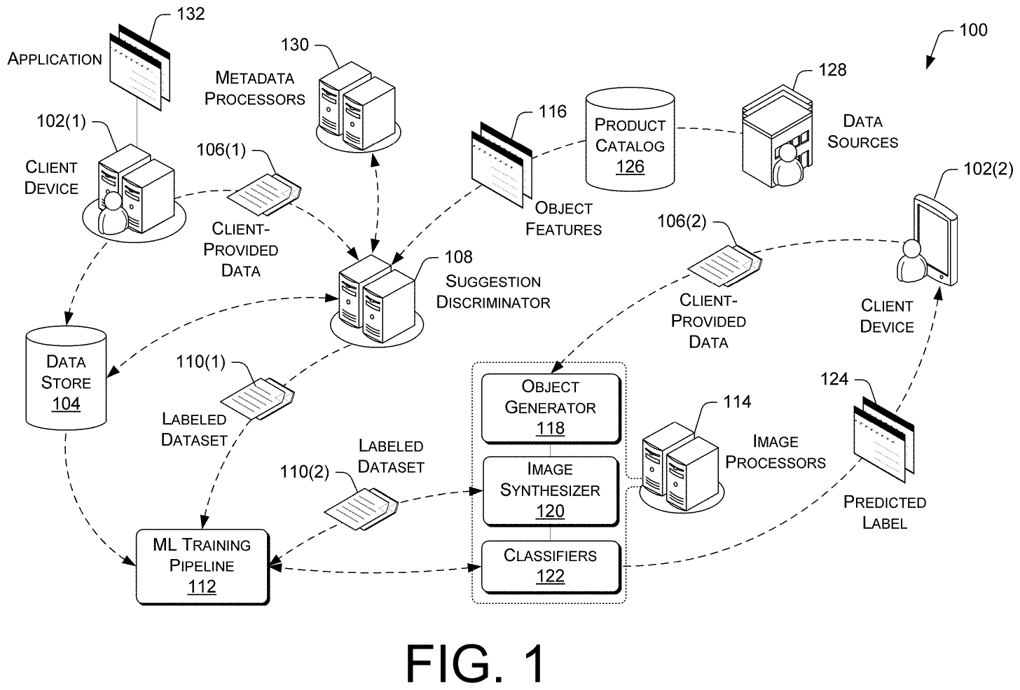

FIG. 1 illustrates an example architecture 100 for providing data attribution based on spatial memory using a machine learning pipeline. In the illustrated embodiment, client-provided data 106(1) and 106(2) may be provided from one or more client devices 102(1) and 102(2). The client devices 102(1) and 102(2) can include smartphones, mobile devices, personal digital assistants (PDAs), or other electronic devices having a wireless communication function that is capable of receiving input, processing the input, and generating output data. The client devices 102(1) and 102(2) are connected to a telecommunication network (e.g., 2G, 3G, 4G, and long-term evolution [LTE], LTE advanced, 5G) utilizing one or more wireless base stations or any other common wireless or wireline network access technologies (e.g., a local area network [LAN], a wide area network [WAN], etc.).

The client-provided data 106(1) and 106(2) may be acquired and stored in a data store 104 with data management services for controlling the data transfer and pulling data from the various data sources. In various embodiments, the client-provided data 106(1) and 106(2) may be stored in a queue (e.g., a data store 104) for processing at a later time. In this regard, the client-provided data 106(1) and 106(2) may be subsequently forwarded to a suggestion discriminator 108 from the data store 104. The data store 104 can comprise a data management layer that includes software utilities for facilitating the acquisition, processing, storing, reporting, and analysis of data from multiple data sources such as the client devices 102(1) and 102(2). In various embodiments, the data store 104 can interface with an API for providing data access.

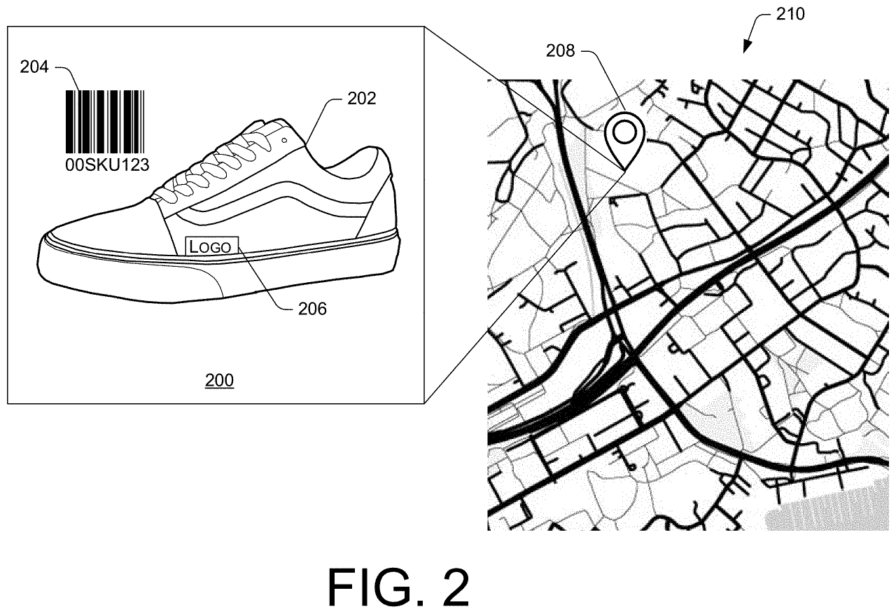

The client-provided data 106(1) and 106(2) may also be directly provided to the suggestion discriminator 108 from one or more data sources 128. The client-provided data 106(1) and 106(2) may include image data corresponding to an image of an object. FIG. 2 shows an example of image 200 of an object 202. The object 202 may be associated with object-specific data, which may be appended to the image 200. The object-specific data may bolster information about object 202 that is shown in the image 200. In some examples, supplemental information such as stock-keeping unit (SKU) number 204, which can comprise a computer-readable code (e.g., a barcode, a QR code, Aztec code, etc.) alone or in combination with alphanumeric characters, and logo 206 comprising text, symbols, and/or other graphical elements may be shown in the image 200.

The supplemental information may provide object-specific data, which can include information about properties and characteristics of the object 202. In one example, the object-specific data can include the product price, color, style, brand, gender, type, size, material, and/or so forth. One or more features may derive from the object-specific data of the object 202. In some aspects, one or more features of the object 202 may be the same or similar to features of other objects even if the other objects are associated with different object-specific data. For example, the object 202 comprises a shoe. The object-specific data of the shoe may be the shoe's price, color, style, brand, gender, type, size, material, and/or so forth. Features such as “water-resistance” may be derived based on the material (e.g., rubber) of the shoe. A different type of shoe such as boots (in a different image) or even a different type of object such as a raincoat may be associated with a different set of object-specific data. Even if object-specific data of the second shoe such as the material (e.g., suede) is different, the second shoe may still include the same features that are associated with the first shoe in the image 200 such as “water resistance.” In some instances, the object-specific data of an object and its features may overlap. For example, the object-specific data of the shoe in FIG. 2 may be associated with a specific price. The features may include a price range. Accordingly, if the price of the shoe is $100.00 as indicated by the SKU 204 and the feature is a price range of $200.00 and under, then the price of the shoe falls within the price range.

The client-provided data 106(1) and 106(2) may also include location data corresponding to a location 208 on a map 210 from which the image 200 was taken. The location data may be retrieved from third-party applications that include check-in features that provide a status update that uses location features of the client devices 102(1) and 102(2). In this way, a user's status update can indicate where the user, and hence the client devices 102(1) and 102(2) is located at the time the image 200 was taken.

Turning back to FIG. 1, the client-provided data 106(1) and 106(2) may also include timestamp associated with the image, version history of the data corresponding to an image, previously acquired data associated with an object in an image, and/or so forth. Additional or supplemental data may be provided from product catalogs 126 that can be managed by one or more data sources 128 such as retailers, vendors, manufacturers, other users, and/or so forth. Additionally, or alternatively, data may be provided from other data sources such as image catalogs, image databases, search engine databases, metadata processors 130 (e.g., barcode scanning and reading systems, sensors, image capture devices, etc.) and/or so forth.

The suggestion discriminator 108 is configured to generate suggestions for categorizing the client-provided data 106(1) and 106(2) received from one or more data sources (e.g., client devices 102(1) and 102(2)). In some aspects, the suggestion discriminator 108 may generate suggestions using one or more image recognition techniques or tools in separate image processors 114. Additionally, or alternatively, the suggestion discriminator 108 may generate suggestions using location data corresponding to a location from which an image was taken, previously acquired data associated with an object shown in an image, user data, metadata, and/or so forth. For example, the location data may correspond to a store or a retail environment and the suggested categories can be based at least on the type of the store or the retail environment. In another example, the suggested categories can be based at least on the labels or categories previously selected or associated with similar images or items. In some aspects, the suggestion discriminator 108 may also obtain additional information from the metadata processors 130 or the product catalog 126 to generate suggestions.

The suggestions for categories may be generic and/or specific. For example, generic suggestions for categorizing an image depicting a smartphone may include “mobile phone” or “personal digital assistant.” In another example, specific suggestions for categorizing the image depicting the smartphone may include specific brand names, names of original equipment manufacturers, material components, and/or model/type of the smartphone. Suggestions may be provided to a user on a graphical user interface (GUI) of a software application 132 that may at least partially reside on the client devices 102(1) and 102(2).

In various embodiments, the user may interact with, via the software application 132 or a third-party application (e.g., an online shopping application). Based on the user interactions and other user behavior based on the interactions, the suggestion discriminator 108 may suggest categories associated with an object shown in an image. For example, the user may search for a “smartphone” and the application may return search results comprising a plurality of images. While most of the images included in the search results may comprise images of smartphones, some of the images included in the search results may not comprise images of smartphones and instead comprise images of other electronic devices (e.g., a tablet computer). If the user selects an image, then the selected image is presumed to be an image of a smartphone. This selection can be fed to the suggestion discriminator 108 and the suggestion discriminator 108 may in turn suggest “phone,” “mobile device,” or other such categories for the selected and/or to create a new category.

In some aspects, the user interactions and other user behavior may reveal or identify jobs to be done. Jobs to be done indicate what the user may need and identify opportunities to provide targeted marketing for specific products related to an object shown in an image or related to user interactions and user behavior. The suggestion discriminator 108 may suggest categories for images based at least on identified jobs to be done. For example, the user may search, via a search function of the software application 132, for a “hot beverage” at a particular time during the day (e.g., morning) and the application may return search results comprising images. Because most people drink coffee or tea in the morning, the search results may mostly comprise images of coffee and tea. If the user selects an image, then the selected image is presumed to be an image of coffee or tea. Accordingly, the suggestion discriminator 108 may suggest categories such as “coffee” or “tea” for the selected image. In another example, the user may search for “goggles” at a particular location and the application may return search results comprising images of various types of goggles such as swim goggles, snow goggles, protective eyewear, and/or so forth. If the location data indicates that the user is located at a ski resort and the user selects an image, then the selected image is presumed to be an image of snow goggles. Accordingly, the suggestion discriminator 108 may suggest categories such as “snow goggles,” “ski goggles,” or “snowboard goggles” for the selected image.

In some embodiments, the selected image may be displayed on the GUI of the software application 132. Based on the suggested category, the software application 132 may retrieve additional images associated with the same suggested category for display on the GUI. The images can comprise marketing materials and advertisements for specific products based on the user's search and the selected image. Additionally, the additional images may show products that the user can purchase via the software application 132. In some examples, the images can comprise a link that can direct the user to a third-party site (e.g., a retailer) to complete a purchase transaction.

Upon generating category suggestions, the suggestion discriminator 108 associates the suggested categories with the respective image to create a labeled dataset 110(1). The labeled dataset 110(1) may be provided to a machine learning pipeline 112, which in turn may use the labeled dataset 110(1) to train and generate machine learning models. The classifiers 122 may be configured to apply machine learning models to output a predicted label 124 associated with an image. In some aspects, the classifier 122 may be configured to determine jobs to be done in order to perform targeted marketing.

In some aspects, the object generator 118 may receive the client-provided data 106(1) and 106(2) to create a three-dimensional asset associated with an object depicted in an image. The three-dimensional asset may be a three-dimensional image of the object that is constructed from a plurality of images of the object from different view angles. The three-dimensional asset may be provided to the image synthesizer 120, which in turn may create computer-generated two-dimensional images of the object using the three-dimensional asset. The image synthesizer may also append information related to the object to the computer-generated two-dimensional images to create a labeled dataset 110(2). The labeled dataset 110(2) may be provided to a machine learning pipeline 112, which in turn may use the labeled dataset 110(2) to train and generate machine learning models.

The various components of FIG. 1 (e.g., the suggestion discriminator 108, the image processors 114, the data store 104, etc.) may include general-purpose computers, such as desktop computers, tablet computers, laptop computers, servers, or other electronic devices that are capable of receiving input, processing the input, and generating output data. Data may be stored in a distributed storage system and replicated to guarantee reliability and to provide data and processing redundancy, in which data processing and data storage may be scaled in response to demand. In various embodiments, the architecture 100 can include a plurality of physical or virtual machines that may be grouped and presented as a single computing system. Each physical machine of the plurality of physical machines may comprise a node in a cluster.

### Example Computing Device Components

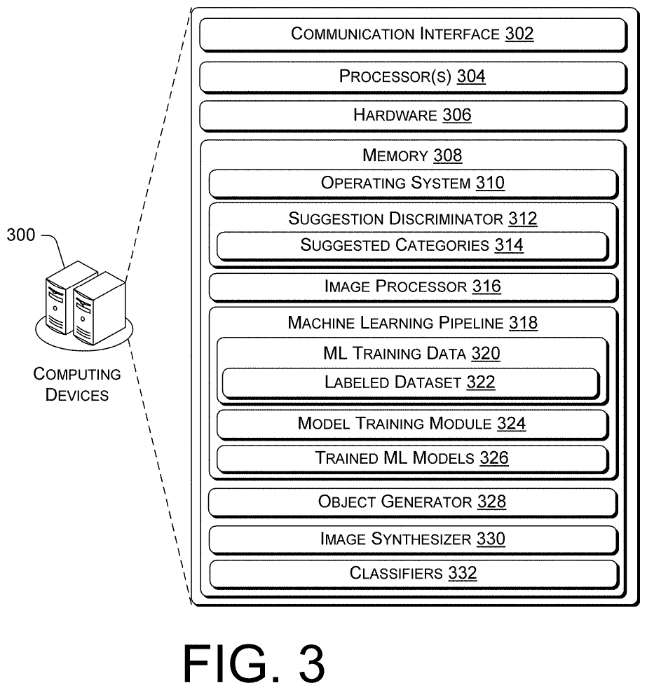

FIG. 3 is a block diagram showing various components of illustrative computing devices 300, wherein the computing devices 300 can comprise a suggestion discriminator, an image processor, and/or other computing devices. It is noted that the computing devices 300 as described herein can operate with more or fewer of the components shown herein. Additionally, the computing devices 300 as shown herein or portions thereof can serve as a representation of one or more of the computing devices of the present system.

The computing devices 300 may include a communication interface 302, one or more processors 304, hardware 306, and memory 308. The communication interface 302 may include wireless and/or wired communication components that enable the computing devices 300 to transmit data to and receive data from other networked devices. In at least one example, the one or more processor(s) 304 may be a central processing unit(s) (CPU), graphics processing unit(s) (GPU), both a CPU and GPU or any other sort of processing unit(s). Each of the one or more processor(s) 304 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution.

The one or more processor(s) 304 may also be responsible for executing all computer applications stored in the memory, which can be associated with common types of volatile (RAM) and/or nonvolatile (ROM) memory. The hardware 306 may include an additional user interface, data communication, or data storage hardware (e.g., solid-state drive [SSD]). For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The memory 308 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 308 may also include a firewall. In some embodiments, the firewall may be implemented as hardware 306 in the computing devices 300.

The processors 304 and the memory 308 of the computing devices 300 may implement an operating system 310. The operating system 310 may include components that enable the computing devices 300 to receive and transmit data via various interfaces (e.g., user controls, communication interface, and/or memory input/output devices), as well as process data using the processors 304 to generate output. The operating system 310 may include a presentation component that presents the output (e.g., display the data on an electronic display, store the data in memory, transmit the data to another electronic device, etc.). Additionally, the operating system 310 may include other components that perform various additional functions generally associated with an operating system.

The processor(s) 304 of the computing devices 300 may execute instructions and perform tasks under the direction of software components that are stored in the memory 308. For example, the memory 308 may store various software components that are executable or accessible by the processor(s) 304 of the computing devices 300. In the illustrated embodiment, the various components may include a suggestion discriminator 312, an image processor 316, a machine learning pipeline 318, an object generator 328, an image synthesizer 330, and one or more classifiers 332.

The suggestion discriminator 312, the image processor 316, the machine learning pipeline 318, the object generator 328, the image synthesizer 330, and the classifiers 332 may include routines, program instructions, objects, and/or data structures that perform particular tasks or implement particular abstract data types. For example, the suggestion discriminator 312 may include one or more instructions, which when executed by the processor(s) 304 direct the computing devices 300 to perform operations related to suggesting categories for an image. However, before suggesting categories, the suggestion discriminator 312 may implement the image processor 316 to perform image processing operations. For instance, the image processor 316 may manage the receiving of images from client devices and other data sources. The individual images may be appended to object-specific data associated with the object. The image processor 316 may manage the timing, speed, and a party (e.g., client devices, data sources) controlling the data transfer. In some aspects, the image processor 316 can act as a data store or communicate with an external data store to receive and store images upon receipt. The image processor 316 may also affirmatively pull images from the client devices, data sources, and other computing devices.

The image processor 316 may preprocess the retrieved images to take partial images, corrupt images, or otherwise substandard images and apply corrections to support further analysis. The image processor 316 may also contain certain logic to remove images with insufficient information or low-quality images. In this way, data collected during the subsequent analysis will not contain data from corrupt or misleading images. This cleaning logic may be part of the image processor 316 or alternatively may be in a separate image cleaning software component.

Once preprocessing is complete, the image processor 316 may identify which portions of an image represent an object to be analyzed as opposed to portions of the image representing items other than the object to be analyzed. The image processor 316 may, therefore, identify discrete objects within the received image and classify those objects by size and image values, either separately or in combination. Example image values include inertia ratio, contour area, and Red-Green-Blue (RGB) components, wherein the inertia ratio is a measure of deformation, the contour area is the extent of a shape or contour, and the RGB components defines hues of a shape or contour. Based on those values, the objects are ranked and sorted. Items above a predetermined threshold or the highest N objects are selected as portions of the received image representing the object of interest.

In some aspects, the image processor 316 may also identify an object in an image. The image processor 316 may compare the image of the object to other images. To perform these comparisons, the image processor 316 may create an object-specific vector comprised of values and value sets generated by an identifying algorithm. Such an object-specific vector corresponds to an object in an image and is compared against other object-specific vectors to perform comparisons. The image processor 316 may also use the object-specific vectors and other information such as object-specific data to map portions of the image to a feature of an object. Accordingly, the image processor 316 may implement various identification algorithms. Some algorithms may work directly on a single image. Other algorithms may process a series of images grouped together into a suggested category, collect information in common, and apply to subsequent images. Example categories may be images of the same model and make of an automobile or groups of vehicle types. Additionally, the image processor 316 may be configured to implement an optical character recognition (OCR) process to read typed and/or handwritten text or machine-readable code (e.g., a bar code, a QR code, etc.) in an image. The OCR process can utilize various decoding algorithms to identify representations of machine-readable code.

The suggestion discriminator 312 may extract one or more features of the object from the object-specific data. In some aspects, the one or more features may be included in a product catalog from one or more data sources. For example, the features can include the name, price, product type or category, location of the object, and/or other features of the object from a product catalog of a retailer. The suggestion discriminator 312 may determine one or more suggested categories 314 for the image based at least on the one or more features of the object and associate the suggested category with the image.

The object generator 328 may include one or more instructions, which when executed by the processor(s) 304 direct the computing devices 300 to perform operations related to create a three-dimensional asset associated with an object depicted in an image. The three-dimensional asset may comprise a three-dimensional image of the object. In one example, the object generator 328 may receive multiple images of an object from one or more data sources (e.g., a client device, image capture device). The individual images may show the object from corresponding unique view angles. For example, a first image may show the object from a first view angle, and a second image may show the object from a second view angle. Additionally, the individual images may be associated with the same label and therefore the same suggested category, in some embodiments. The object generator 328 may be configured to constructing a three-dimensional image of the object based at least on the individual images arranged according to the corresponding unique view angles of the individual additional images. The individual images may be substantially aligned with respect to each other. In some aspects, the object generator 328 may implement an image stitching process to create a three-dimensional image. The image stitching process may include splicing the individual images into pixels and calculating the mapping matrix using an image stitching algorithm for each pixel. Upon calculating the mapping matrix, each pixel is mapped to relate pixel coordinates in one image to pixel coordinates in another image and output a stitched image. The three-dimensional images of the object may be displayed on a client device.

The image synthesizer 330 may include one or more instructions, which when executed by the processor(s) 304 direct the computing devices 300 to perform operations related to creating an additional labeled dataset 322. In one aspect, the image synthesizer 330 may provide one or more computer-generated two-dimensional images from the three-dimensional asset. The two-dimensional images may comprise images of the object from corresponding missing view angles. Accordingly, the image synthesizer 330 may initially identify a missing image portraying the object from a specific view angle of the object. In some aspects, the image synthesizer 330 may utilize various image patching, content aware fill, and/or related techniques to generate the missing image of the object based at least on the one or more features of the object and/or the images arranged according to the corresponding unique view angles of the individual images. Upon creating the two-dimensional images, the image synthesizer 330 may append information related to the object to the two-dimensional images to create an additional labeled dataset. The labeled dataset 322 may be provided to a machine learning pipeline 318, which in turn may use the labeled dataset 322 to train and generate machine learning models 326.

The machine learning pipeline 318 may include machine learning training data 320, a model training module 324, and trained machine learning models 326. The model training module 324 may receive the machine learning training data 320 comprised of labeled dataset 322 from the suggestion discriminator 312 and/or from the image synthesizer 330. The machine learning training data 320 may also include data collected from multiple data sources and optionally a set of desired outputs for the training data. For example, the data that is received may include a set of images with associated labels.

The model training module 324 may use feature engineering to pinpoint features in the training data 320. Accordingly, feature engineering may be used by the model training module 324 to figure out the significant properties and relationships of the input datasets that aid a model to distinguish between different classes of data. The model training module 324 may perform outlier detection analysis, feature composition analysis, and feature relevance analysis during feature engineering. In the outlier detection analysis, the model training module 324 may detect outlier features for exclusion from use in the generation of a machine learning model. Individual features may also be weighted such that outlier features may have less impact on training a machine learning model. In various embodiments, the outlier detection analysis may be performed using a clustering algorithm, such as a k-means algorithm, a Gaussian mixture algorithm, a bisecting k-means algorithm, a streaming k-means algorithm, or another outlier detection algorithm.

In the feature composition analysis, the model training module 324 may perform at least some of the multiple features in the training data 320 into a single feature. Accordingly, feature composition may decrease the number of input features while preserving the characteristics of the features. This decrease in the number of features may reduce the noise in the training data 320. As a result, the composition feature that is derived from the multiple features may improve the classification results for the training data 320. In various implementations, the feature composition analysis may be performed using various dimensionality reduction algorithms, such as a Singular Value Decomposition (SVD) algorithm, a Principal Component Analysis (PCA) algorithm, or another type of dimensionality reduction algorithm.

In the feature relevance analysis, the model training module 324 may identify redundant features in the training data 320 to eliminate such features from being used in the training of the machine learning model. An excessive number of features may cause a machine learning algorithm to over-fit training data 320 or slow down the training process. In various implementations, the feature relevance analysis may be performed using a dimensionality reduction algorithm (e.g., the PCA algorithm, a statistics algorithm, and/or so forth). The statistics algorithm may be a summary statistics algorithm, a correlation algorithm, a stratified sampling algorithm, and/or so forth.

The model training module 324 may generate trained machine learning models 326 following the feature engineering. The model training module 324 may select an initial type of machine learning algorithm to train a machine learning model using the training data 320. In one example, the model training module 324 may model the distribution of features based on location data associated with an image of an object. In such a scenario, the model training module 324 may make a prediction for the label based on the assumption that a specific set of features is associated with limited types of objects that are present in certain locations. More particularly, if an image is associated with location data corresponding to a book store, the model training module 324 may make a prediction for the label based on the assumption that features associated with objects categorized as books and other printed materials are present in the book store.

Following the application of a selected machine learning algorithm to the training data 320, the model training module 324 may determine a training error measurement of the machine learning model. The training error measurement may indicate the accuracy of the machine learning model in generating a solution. Accordingly, if the training error measurement exceeds a training error threshold, the model training module 324 may select an additional type of machine learning algorithm based on a magnitude of the training error measurement. The training error threshold may be a stabilized error value that is greater than zero. In various embodiments, the model training module 324 may implement algorithm selection rules that match specific ranges of training error measurement values to specific types of machine learning algorithms. The different types of machine learning algorithms may include a Bayesian algorithm, a decision tree algorithm, an SVM algorithm, an ensemble of trees algorithm (e.g., random forests and gradient-boosted trees), an isotonic regression algorithm, and/or so forth.

Following the selection of the additional type of machine learning algorithm, the model training module 324 may execute the additional type of machine learning algorithm on the training data 320 to generate training results. In some instances, the model training module 324 may also supplement the training data 320 with additional training data prior to the additional execution. The generated training results are then incorporated by the model training module 324 into the machine learning model. Subsequently, the model training module 324 may repeat the determination of the training error measurement for the machine learning model, and the selection of one or more types of additional machine learning algorithms to augment the machine learning model with additional training results until the training error measurement is at or below the training error threshold. Accordingly, the model training module 324 may use one or more machine learning algorithms to generate a trained machine learning model 326.

The classifiers 332 may include one or more instructions, which when executed by the processor(s) 304 direct the computing devices 300 to perform operations related to predicting a label for an image of an object. The classifiers 332 may apply the trained machine learning model 326 to assign a label to an image. In one aspect, the classifiers 332 may predict multiple labels for a single image. For example, the image of a shoe in FIG. 2 may be labeled with “men's shoes,” “sneakers,” “VANS™,” and/or so forth.

Additionally, one or more of the classifiers 332 may be selected from a plurality of classifiers to predict a label for an image of an object. The individual classifiers 332 may apply different machine learning models trained using different machine learning algorithms. In one example, one of the classifiers 332 may be selected based at least on location data associated with the image. For example, the classifier may be selected if the location data corresponds to a grocery store. In another example, a different classifier may be selected if the location data corresponds to a department store. The two different classifiers may predict a label from a selected set of labels that correspond to products that are likely to be sold or to objects that are likely to be found at the respective locations. For instance, a classifier may predict a label from a selected set of labels that correspond to food items that are likely to be found at grocery stores. Similarly, another classifier may predict a different label from an additional set of labels that correspond to clothing and home goods that are likely to be found at department stores.

Additionally, or alternatively, a classifier may be selected based at least on the type or the characteristics of an object depicted in the image. The type or the characteristics of an object may be determined based at least on the suggested categories 314 associated with the image and/or other information associated with the image analyzed via the image processor 316. For example, a classifier may be selected if the object depicted in the image comprises an electronic device. In another example, a different classifier may be selected if the object depicted in the image comprises jewelry. The two different classifiers may predict a label from a selected set of labels that correspond to the respective objects. For instance, the classifier may predict a label from a selected set of labels that correspond to electronics. Similarly, another classifier may predict a different label from an additional set of labels that correspond to jewelry and accessories. This selection logic may be part of the classifiers 332. Multiple classifiers may also operate in parallel. In one aspect, the classifiers 332 may implement a pipeline that uses parallel tasks on virtual machines. Additionally, or alternatively, the selection logic may be in a separate classifier selection software component such as a lightweight switch network that determines which classifier to label an image.

### Example Processes

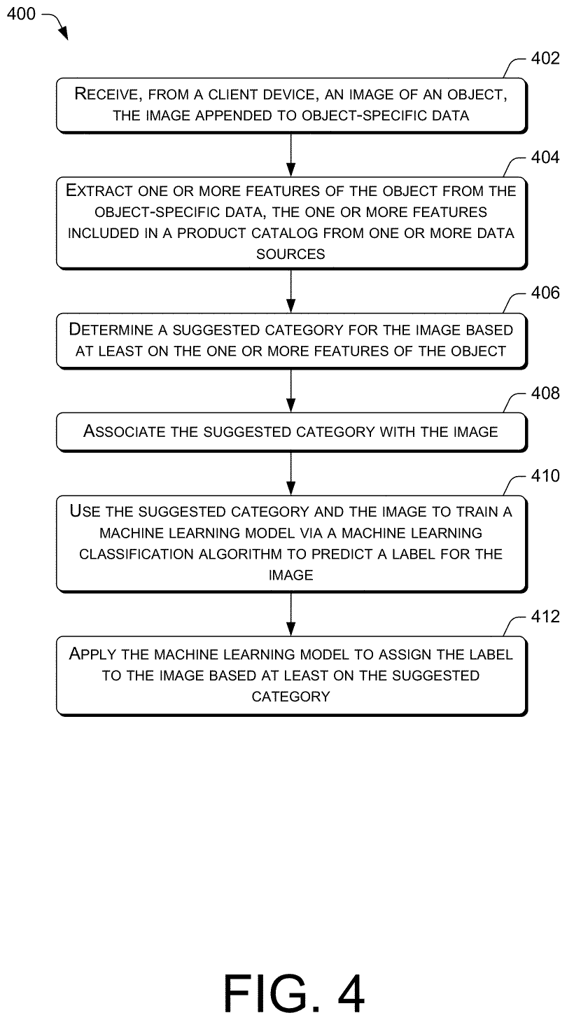

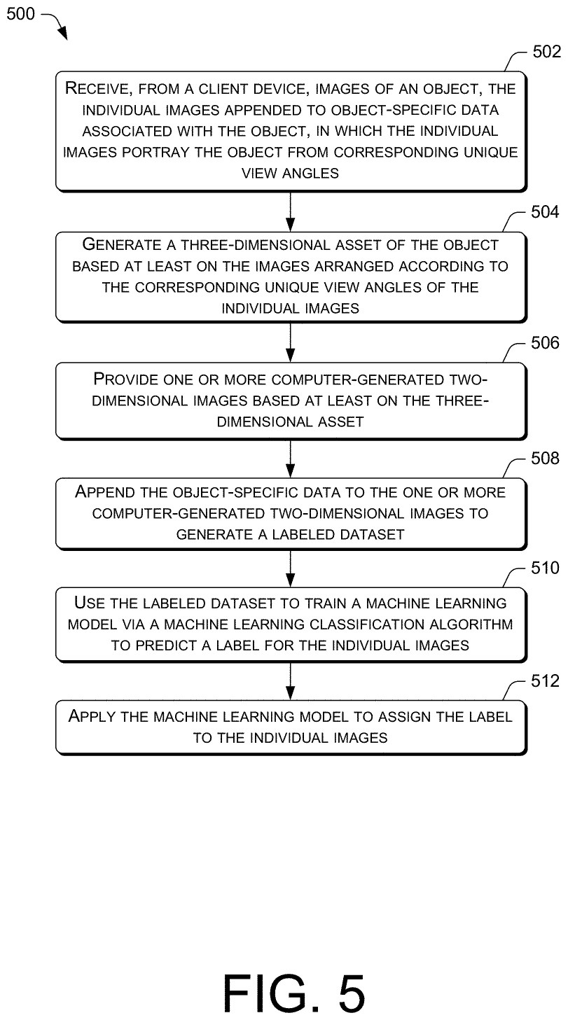

FIGS. 4 and 5 present illustrative processes 400 and 500 for providing data attribution based on spatial memory using a machine learning pipeline. The processes 400 and 500 are illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 400 and 500 are described with reference to FIGS. 1-3.

FIG. 4 is a flow diagram of an example process for predicting a label associated with client-provided data. At block 402, a suggestion discriminator receives, from a client device, an image of an object, the image appended to object-specific data associated with the object. The object-specific data may include image data corresponding to the image. The object-specific data may comprise information about the object that is shown in the image. The object-specific data of the shoe may be the object's price, color, style, brand, gender, type, size, material, and/or so forth.

At block 404, the suggestion discriminator extracts one or more features of the object from the object-specific data. The one or more features may be included in a product catalog from one or more data sources. For example, the features can include the name of the object from a product catalog of a retailer. At block 406, the suggestion discriminator determines a suggested category for the image based at least on the one or more features of the object. At block 408, the suggestion discriminator associates the suggested category with the image.

At block 410, a machine learning pipeline may use the suggested category and the image to train a machine learning model via a machine learning classification algorithm to predict a label for the image. At block 412, a classifier applies the machine learning model to assign the label to the image based at least on the suggested category. In some aspects, the classifier may apply different machine learning models trained using different machine learning algorithms.

FIG. 5 is a flow diagram of an example process for generating a three-dimensional object based on client-provided data. At block 502, a suggestion discriminator receives, from a client device, images of an object, the individual images appended to object-specific data associated with the object, in which the individual images portray the object from corresponding unique view angles. The view angles may partially overlap. For example, one image may show a side planar view of the object, and the image may partially overlap with another image showing a perspective view of the object. Additionally, or alternatively, one image may show a top-down view of the object, and the image may not overlap with another image showing a bottom view of the object. At block 504, an object generator generates a three-dimensional asset of the object based at least on the images arranged according to the corresponding unique view angles of the individual images. In some aspects, the object generator may implement an image stitching process to create a three-dimensional asset.

At block 506, the image synthesizer may provide one or more computer-generated two-dimensional images based at least on the three-dimensional asset. The one or more two-dimensional images may comprise images corresponding to missing view angles of the object. At block 508, the image synthesizer may append the object-specific data to the one or more computer-generated two-dimensional images to generate a labeled dataset. At block 510, a machine learning pipeline may use the labeled dataset to train a machine learning model via a machine learning classification algorithm to predict a label for the individual images. At block 512, a classifier applies the machine learning model to assign the label to the individual images. In some aspects, the classifier may apply different machine learning models trained using different machine learning algorithms.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable instructions that upon execution cause one or more processors to perform acts comprising:
receiving, from a client device, an image of an object, the image appended to object-specific data associated with the object;
extracting one or more features of the object from the object-specific data, the one or more features included in a product catalog from one or more data sources;
determining a suggested category for the image based at least on the one or more features of the object;
associating the suggested category with the image;
using the suggested category and the image to train a machine learning model via a machine learning classification algorithm to predict a label for the image; and
applying the machine learning model to assign the label to the image based at least on the suggested category.

2. The one or more non-transitory computer-readable media of claim 1, wherein the acts further comprise:
receiving, from the client device, additional images of the object, the individual additional images portraying the object from corresponding unique view angles and associated with the label;
constructing a three-dimensional image of the object based at least on the individual additional images arranged according to the corresponding unique view angles of the individual additional images; and
displaying the three-dimensional image of the object via the client device.

3. The one or more non-transitory computer-readable media of claim 1, wherein the acts further comprise:
assigning an additional label to the image via the machine learning classification algorithm based at least on the suggested category;
determining a ranking for the label and the additional label via a machine learning ranking algorithm; and
assigning the ranking for the label and the additional label.

4. The one or more non-transitory computer-readable media of claim 1, wherein the acts further comprise:
receiving a request to label an additional image of the object;
determining whether the additional image is associated with the suggested category; and
if the additional image is associated with the suggested category, applying the machine learning model to assign the label to the additional image based at least on the suggested category.

5. The one or more non-transitory computer-readable media of claim 1, wherein the acts further comprise:
identifying one or more information associated with the object from the image, wherein the one or more information comprises at least one of text, logos, and computer-readable code; and
determining the suggested category for the image based at least on the one or more information.

6. The one or more non-transitory computer-readable media of claim 5, wherein the acts further comprise:
selecting the machine learning classification algorithm from a plurality of machine learning classification algorithms based at least on the one or more information.

7. The one or more non-transitory computer-readable media of claim 1, wherein the one or more features comprise at least one of a name of the object, price of the object, retailer of the object, and product type and category associated with the object.

8. The one or more non-transitory computer-readable media of claim 1, wherein the image is associated with location data and the acts further comprise:
using the location data to train a location-based machine learning model via a location-based machine learning classification algorithm to select the label from a subset of labels of a plurality of labels; and
applying the location-based machine learning model to assign the label to the image based at least on the location data.

9. A system, comprising:
one or more non-transitory storage mediums configured to provide stored computer-readable instructions, the one or more non-transitory storage mediums coupled to one or more processors, the one or more processors configured to execute the computer-readable instructions to cause the one or more processors to:
receive, from a client device, an image of an object, the image appended to object-specific data associated with the object;
extract one or more features of the object from the object-specific data, the one or more features included in a product catalog from one or more data sources;
determine a suggested category for the image based at least on the one or more features of the object;
associate the suggested category with the image;
use the suggested category and the image to train a machine learning model via a machine learning classification algorithm to predict a label for the image; and
apply the machine learning model to assign the label to the image based at least on the suggested category.

10. The system of claim 9, wherein the one or more processors are further configured to:
receive, from the client device, additional images of the object, the individual additional images portraying the object from corresponding unique view angles and associated with the label;
construct a three-dimensional image of the object based at least on the individual additional images arranged according to the corresponding unique view angles of the individual additional images; and
display the three-dimensional image of the object via the client device.

11. The system of claim 9, wherein the one or more processors are further configured to:
assign an additional label to the image via the machine learning classification algorithm based at least on the suggested category;
determine a ranking for the label and the additional label via a machine learning ranking algorithm; and
assign the ranking for the label and the additional label.

12. The system of claim 9, wherein the one or more processors are further configured to:
receive a request to label an additional image of the object;
determine whether the additional image is associated with the suggested category; and
if the additional image is associated with the suggested category, apply the machine learning model to assign the label to the additional image based at least on the suggested category.

13. The system of claim 9, wherein the one or more processors are further configured to:
identify one or more information associated with the object from the image, wherein the one or more information comprises at least one of text, logos, and computer-readable code; and
determine the suggested category for the image based at least on the one or more information.

14. The system of claim 13, wherein the one or more processors are further configured to:
select the machine learning classification algorithm from a plurality of machine learning classification algorithms based at least on the one or more information.

15. The system of claim 9, wherein the image is associated with location data and the one or more processors are further configured to:
use the location data to train a location-based machine learning model via a location-based machine learning classification algorithm to select the label from a subset of labels of a plurality of labels; and
apply the location-based machine learning model to assign the label to the image based at least on the location data.

16. The system of claim 9, wherein the one or more processors are further configured to:
store the suggested category for the image.

17. A computer-implemented method, comprising:
receiving, from a client device, images of an object, the individual images appended to object-specific data associated with the object and portraying the object from corresponding unique view angles;
generating a three-dimensional asset of the object based at least on the images arranged according to the corresponding unique view angles of the individual images;
providing one or more computer-generated two-dimensional images based at least on the three-dimensional asset;
appending the object-specific data to the one or more computer-generated two-dimensional images to generate a labeled dataset;
using the labeled dataset to train a machine learning model via a machine learning classification algorithm to predict a label for the individual images; and
applying the machine learning model to assign the label to the individual images.

18. The computer-implemented method of claim 17, wherein the three-dimensional asset comprises a three-dimensional image, and further comprising:
rendering, on the client device, the three-dimensional image as an overlay to a real environment.

19. The computer-implemented method of claim 17, further comprising:
identifying a missing image portraying the object from a specific view angle of the object;
generating the missing image of the object based at least on the one or more features of the object and the images arranged according to the corresponding unique view angles of the individual images; and
updating the three-dimensional asset of the object based at least on the missing image and the images arranged according to the corresponding unique view angles of the missing image and the individual images.

20. The computer-implemented method of claim 17, further comprising:
identifying additional features based at least on the label assigned to the individual images; and
determining a suggested category for the individual images based at least on the additional features associated with the object.
